(19) United States
(12) Patent Application Publication
(10) Pub. No.: US 2022/0406119 A1
(43) Pub. Date: Dec. 22, 2022

(54) METHOD AND APPARATUS FOR DETECTING TOKENS ON GAME TABLE, DEVICE, AND STORAGE MEDIUM

(71) Applicant: SENSETIME INTERNATIONAL PTE. LTD., Singapore (SG)

(72) Inventors: Miao OUYANG, Singapore (SG); Xinxin WANG, Singapore (SG)

(21) Appl. No.: 17/364,269

(22) Filed: Jun. 30, 2021

Related U.S. Application Data
(63) Continuation of application No. PCT/IB2021/055692, filed on Jun. 25, 2021.

(30) Foreign Application Priority Data
Jun. 18, 2021 (SG) 10202106613W

(51) Int. Cl. G07F 17/32; G06K 9/00

(52) U.S. Cl. CPC G07F 17/322; G07F 17/3232; G07F 17/3241; G07F 17/3251; G06K 9/00744; G06K 9/00771

(57) ABSTRACT

The embodiments of the application provide a method for detecting tokens on a game table, which includes that: in response to that a game enters a game prop operating stage after a token placement stage, a target region where a token is changed in multiple regions for token placement on a game table is determined based on at least one frame of image of the game table, the token in each region being configured to perform payout according to an operation result of a game prop in a payout stage of the game; and in a case where the target region is not a preset region that allows the token to be changed, alarm information for the target region is generated. The embodiments of the application also provide an apparatus for detecting tokens on a game table, a device, and a storage medium.

### CROSS-REFERENCE TO RELATED APPLICATION

This is continuation application of international application PCT/IB2021/055692, filed on 25 Jun. 2021, which claims priority to Singaporean patent application No. 10202106613W, filed with IPOS on 18 Jun. 2021. The contents of international application PCT/IB2021/055692 and Singaporean patent application No. 10202106613W are incorporated herein by reference in their entireties.

### TECHNICAL FIELD

The application relates to the technical field of computer vision, and relates, but not limited, to a method and apparatus for detecting tokens on a game table, a device, and a storage medium.

### BACKGROUND

In a game place, there is usually a certain game rule required to be followed in a table game, and thus a behavior of a gamer and change states of a game prop and tokens on a game tabletop are required to be supervised to avoid the loss of the game place or gamers. In the related art, whether a participant of a game follows a game rule is manually supervised, which is somewhat subjective and brings a certain time delay.

### SUMMARY

Embodiments of the application provide a method and apparatus for detecting tokens on a game table, a device, and a storage medium.

The technical solutions of the embodiments of the application are implemented as follows.

According to a first aspect, the embodiments of the application provide a method for detecting tokens on a game table, which may include the following operations.

In response to that a game enters a game prop operating stage after a token placement stage, a target region where a token is changed in multiple regions for token placement on a game table is determined based on at least one frame of image of the game table, the token in each region being configured to perform payout according to an operation result of a game prop in a payout stage of the game.

In a case where the target region is not a preset region that allows the token to be changed, alarm information for the target region is generated.

According to a second aspect, the embodiments of the application provide an apparatus for detecting tokens on a game table, which may be applied to an edge computing node and include a first determination module and a generation module.

The first determination module may be configured to, in response to that a game enters a game prop operating stage after a token placement stage, determine a target region where a token is changed in multiple regions for token placement on a game table based on at least one frame of image of the game table, the token in each region being configured to perform payout according to an operation result of a game prop in a payout stage of the game.

The generation module may be configured to, in a case where the target region is not a preset region that allows the token to be changed, generate alarm information for the target region.

According to a third aspect, the embodiments of the application provide an electronic device, which may include a memory and a processor. The memory may store a computer program capable of running in the processor. The processor may execute the program to implement the steps in the abovementioned method for detecting tokens on a game table.

According to a fourth aspect, the embodiments of the application provide a computer-readable storage medium, in which a computer program may be stored, the computer program being executed by a processor to implement the steps in the abovementioned method for detecting tokens on a game table.

The technical solutions provided in the embodiments of the application at least have the following beneficial effects.

In the embodiments of the application, first, in response to that the game enters the game prop operating stage after the token placement stage, the target region where the token is changed in the multiple regions for token placement on the game table is determined based on the at least one frame of image, the token in each region being configured to perform payout according to the operation result of the game prop in the payout stage of the game. Then, in a case where the target region is not the preset region that allows the token to be changed, the alarm information for the target region is generated. Accordingly, whether the token that has been placed in each region is changed in the game prop operating stage is detected to determine the target region, and meanwhile, a target region of a preset type is protected, so that the situation that the game cannot be played smoothly due to mistaken triggering of alarm by a normal operational behavior is reduced.

### BRIEF DESCRIPTION OF THE DRAWINGS

In order to describe the technical solutions of the embodiments of the application more clearly, the drawings required to be used in the descriptions about the embodiments will be simply introduced below. It is apparent that the drawings described below are merely some embodiments of the application. Other drawings may further be obtained by those of ordinary skill in the art according to these drawings without creative work.

FIG. 1 is a structure diagram of a system for detecting tokens on a game table according to an embodiment of the application.

FIG. 2 is a flowchart of a method for detecting tokens on a game table according to an embodiment of the application.

FIG. 3 is a flowchart of a method for detecting tokens on a game table according to an embodiment of the application.

FIG. 4 is a flowchart of a method for detecting tokens on a game table according to an embodiment of the application.

FIG. 5 is a flowchart of a method for detecting tokens on a game table according to an embodiment of the application.

FIG. 6 is a flowchart of a method for detecting tokens on a game table according to an embodiment of the application.

FIG. 7A is a state flowchart of a game process according to an embodiment of the application.

FIG. 7B is a logic flowchart of a method for detecting tokens on a game table according to an embodiment of the application.

FIG. 7C is a flowchart of chip detection in a gaming stage according to an embodiment of the application.

FIG. 8 is a composition structure diagram of an apparatus for detecting tokens on a game table according to an embodiment of the application.

FIG. 9 is a schematic diagram of hardware entities of an electronic device according to an embodiment of the application.

### DETAILED DESCRIPTION

In order to make the purpose, technical solutions, and advantages of the embodiments of the application clearer, the technical solutions in the embodiments of the application will be clearly and completely described below in combination with the drawings in the embodiments of the application. It is apparent that the described embodiments are not all embodiments but part of embodiments of the application. The following embodiments are adopted to describe the application rather than limit the scope of the application. All other embodiments obtained by those of ordinary skill in the art on the basis of the embodiments in the application without creative work shall fall within the scope of protection of the application.

“Some embodiments” involved in the following descriptions describes a subset of all possible embodiments. However, it can be understood that “some embodiments” may be the same subset or different subsets of all the possible embodiments, and may be combined without conflicts.

It is to be pointed out that term “first/second/third” involved in the embodiments of the application is only for distinguishing similar objects and does not represent a specific sequence of the objects. It can be understood that “first/second/third” may be interchanged to specific sequences or orders if allowed to implement the embodiments of the application described herein in sequences except the illustrated or described ones.

Those skilled in the art can understand that, unless otherwise defined, all the terms (including technical terms and scientific terms) used herein have the same meanings usually understood by those of ordinary skill in the art of the embodiments of the application. It should also be understood that terms defined in, for example, a general dictionary, should be understood to have the same meanings as those in the context of the conventional art, and may not be explained as idealized or too formal meanings, unless otherwise specifically defined like those here.

Computer vision, as a science researching how to make machines “see”, refers to recognizing, tracking and measuring targets using video cameras and computers instead of human eyes and further performing image processing.

Image recognition technology: the image recognition technology may be based on a main feature of an image. Each image has its own feature. For example, letter A has a tip, P has a circle, and Y has an acute angle in the center. Researches on eye movements during image recognition show that the sight is fixed upon main features of an image, namely fixed upon positions where a contour curvature of the image is maximum or a contour direction changes suddenly, and there is most information at these positions. Moreover, a scanning route of the eye always sequentially turns from one feature to another feature. It can thus be seen that a perceptual mechanism needs to exclude redundant input information and extract key information in an image recognition process. In addition, a mechanism responsible for integration in the brain is required to integrate information obtained by stages into a complete perceptual impression.

In a human image recognition system, recognition of a complex image may usually be implemented by information processing of different layers. For a familiar image, since its main feature is mastered, the image may be recognized as a unit, without focusing on its details. Such an integrated unit formed by isolated unit materials is called a block, and each block is perceived at the same time. In recognition of a written material, a person may recognize not only a block formed by units such as strokes or radical of a Chinese character but also a block unit formed by words or phrases that often appear together.

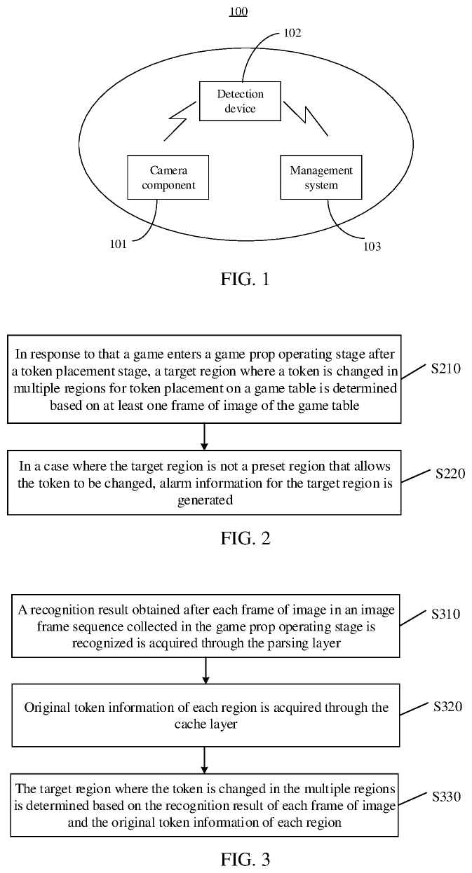

FIG. 1 is a structure diagram of a system for detecting tokens on a game table according to an embodiment of the application. As shown in FIG. 1, the system 100 may include a camera component 101, a detection device 102, and a management system 103.

In some implementation modes, the camera component 101 may be a bird's eye camera component. The camera component 101 may include multiple cameras, and the multiple cameras may shoot a game table from different angles.

In some implementation modes, the detection device 102 may correspond to one camera component 101. In some other implementation modes, the detection device 102 may correspond to multiple camera components 101. For example, the multiple camera components 101 corresponding to the detection device 102 may be camera components 101 configured to shoot game tables in one or more game places. Alternatively, the multiple camera components 101 corresponding to the detection device 102 may be camera components 101 configured to shoot game tables in part of regions in a game place. The part of regions may be common regions, Very Important Person (VIP) regions, etc.

In some implementation modes, the detection device 102 may be arranged in a game place. In some other implementation modes, the detection device 102 may be arranged in a cloud. The detection device 102 may be connected with a server in the game place.

The camera component 101 may be in communication connection with the detection device 102. In some implementation modes, the camera component 101 may shoot real-time images periodically or aperiodically, and send the shot real-time images to the detection device 102. For example, in a case where the camera component 101 includes multiple cameras, the multiple cameras may shoot real-time images at an interval of a target time length, and send the shot real-time images to the detection device 102. The multiple cameras may shoot real-time images at the same time or at different time. In some other implementation modes, the camera component 101 may shoot real-time videos, and send the real-time videos to the detection device 102. For example, in a case where the camera component 101 includes multiple cameras, the multiple cameras may send shot real-time videos to the detection device 102 respectively such that the detection 102 extracts real-time images from the real-time videos. The real-time image in the embodiments of the application may be any one or more of the following images.

In some implementation modes, the camera component may keep shooting images, thereby keeping sending the shot images to the detection device 102. In some other implementation modes, the camera component may be triggered by a target to shoot an image. For example, the camera component may start shooting an image in response to an instruction that a game result comes out or a token is placed.

The detection device 102 may analyze the game table and a game controller and gamer at the game table in the game place based on the real-time image to determine whether actions of the game controller and/or the gamer conform to rules or are proper.

The detection device 102 may be in communication connection with the management system 103. In a case where the detection device 102 determines that the actions of the game controller or the gamer are improper, for reducing the loss of a casino or gamers, the detection device 102 may send a target alarm to the management system 103 on the game table corresponding to the game controller or gamer whose actions are improper such that the management system 103 may give an alarm corresponding to the target alarm to alarm the game controller or the gamer through the game table to reduce the condition that the improper actions of the game controller or the gamer cause the loss of the game place or the gamers.

In some embodiments, the detection device 102 may include an edge device, or an Artificial Intelligence (AI) node. The detection device 102 may be connected with the server, so that the server may correspondingly control the detection device, and/or, the detection device may use service provided by the server.

In some implementation modes, the management system 103 may include a display device, and the display device is configured to display an identifier of at least one region, an alarming reason of at least one gamer, etc. In some other implementation modes, the management system 103 may include a sub-apparatus corresponding to each region on the game table, and each sub-apparatus may include at least one of a display apparatus, a sound production apparatus, a light emitting apparatus, or a vibration apparatus.

The embodiments of the application are not limited thereto. In the embodiment corresponding to FIG. 1, the camera component 101, detection device 102 and management system 103 that are presented are independent respectively. However, in another embodiment, the camera component 101 and the detection device 102 may integrated, or, the detection device 102 and the management system 103 may be integrated.

A method for detecting tokens on a game table in the embodiments of the application will be described below. According to the method, the token in each region on a game table after a game prop operating stage is entered may be supervised. In a case where a person continue betting to a region or removes the token in the region, whether a type of the region is a regional type that allows additional bets such as an insured type is further determined. For a region of the regional type that allows additional bets such as the insured type, an alarm for the region is required to be shielded. Therefore, the condition that a game cannot be played smoothly due to mistaken triggering of alarming by a normal behavior of a gamer or a game controller is reduced.

FIG. 2 is a flowchart of a method for detecting tokens on a game table according to an embodiment of the application. As shown in FIG. 2, the method is applied to an edge computing node (arranged in the abovementioned detection device 102). The method at least includes the following operations.

In S210, in response to that a game enters a game prop operating stage after a token placement stage, a target region where a token is changed in multiple regions for token placement on a game table is determined based on at least one frame of image of the game table.

Here, the token in each region is configured to perform payout according to an operation result of a game prop in a payout stage of the game.

Here, the token is placed by a gamer participating in the game before the game prop operating stage. That is, all gamers have placed a token for participating in a game process in corresponding regions. At least one region may be a token placement region configured to represent at least one token holder on the game table.

It can be understood that, after all gamers have completed operations of placing tokens in corresponding regions in a round of game, the game controller starts a game prop operation such that the game enters the game prop operating stage. The game controller is a manager or robot that controls the game stages and collects tokens for payout. In some embodiments, a game prop may be a card, a chess piece, etc. Taking card as an example for description, the game prop operating stage may be a gaming stage. The game on the game table may be a card game or a non-card game, and may be Baccarat, Golden Flower, Niuniu, Fishing Joy, Texas Poker, one-arm bandit, show-hand, Pai Gow, Landlords, etc.

For convenient understanding, in another embodiment of the application, descriptions are made with a card game as an example.

In some implementation modes, the token in each region on the game table before and after the game prop operating stage may be recognized to determine the target region where the token is changed after the game prop operating stage. In response to recognizing that the game controller operates the game prop for the first time, it is determined that the game enters the game prop operating stage. In some other implementation modes, original token information of each region may be stored, and real-time present token information of each region in each frame of image is compared with the original token information of the corresponding region based on an image sequence collected after the game prop operating stage is entered to determine the target region where the token is changed.

In S220, in a case where the target region is not a preset region that allows the token to be changed, alarm information for the target region is generated.

Here, an application scene of the game table may include, but not limited to, a scene that gamer A is a banker and another gamer is a player, a scene that gamer A is simultaneously the banker and the player, a scene that all the gamers are players, etc.

Corresponding to different application scenes of the game table, the target region may include a first-type region (the preset region that allows the token to be changed) and a second-type region. Changing the token in the first-type region in the game prop operating stage may not affect payout in the game. The token in the second-type region is a basis for payout in the game, and the token in the second-type region is required to be kept unchanged after a token placement state is ended until payout in the game is completed. The first-type region includes a player insured region and a banker insured region. The second-type region includes a player region and a banker region.

In some implementation modes, the game controller may place a type identifier in a corresponding region in the game process to set a type of the region. In some other implementation modes, types of different regions may be pre-configured before the game is started. For example, different regions may be coded to identify a type of each region.

Here, the preset region that allows the token to be changed is a region that allows the token to be changed in the game prop operating stage. For example, the gamer may continue placing tokens in the target region or remove the token in the game prop operating stage.

In the embodiment of the application, first, in response to that the game enters the game prop operating stage after the token placement stage, the target region where the token is changed in the multiple regions for token placement on the game table is determined based on the at least one frame of image, the token in each region being configured to perform payout according to the operation result of the game prop in the payout stage of the game. Then, in a case where the target region is not the preset region that allows the token to be changed, the alarm information for the target region is generated. Accordingly, whether the token that has been placed in each region is changed in the game prop operating stage is detected to determine the target region, and meanwhile, a target region of a preset type is protected, so that the condition that the game cannot be played smoothly due to mistaken triggering of alarming by a normal operational behavior is reduced.

In some possible embodiments, the method for detecting tokens on a game table is applied to a service layer of the edge computing node. The edge computing node further includes a parsing layer and a cache layer. FIG. 3 is a flowchart of a method for detecting tokens on a game table according to an embodiment of the application. As shown in FIG. 3, the method at least includes the following operations.

In S310, a recognition result obtained after each frame of image in an image frame sequence collected in the game prop operating stage is recognized is acquired through the parsing layer.

It is to be noted that multiple algorithm models, such as a target detection algorithm, a recognition algorithm, and a correlation algorithm, are configured in the parsing layer to perform image recognition on an image frame sequence collected by a specific camera (arranged above the game table) to obtain a detection and recognition result of each frame of image. The target detection algorithm is configured to output a target object position (detection box) in an environment and a detection type, including all tokens, cash, playing cards, human bodies, faces, and hands. The recognition algorithm recognizes an object of a type according to an output of the target detection algorithm. For example, a token box is given, and a face value and type of the token are recognized.

The service layer acquires the detection and recognition result from the parsing layer for service logic processing, and interacts with an internal Casinos Management System (CMS) of a game place.

The image frame sequence is obtained through the following process. The parsing layer acquires video sequences collected by at least two cameras according to a specific time interval. The video sequences collected by the at least two cameras are composited according to time to obtain the image frame sequence. As such, the token and hand actions on the game table may be detected from different angles through multiple cameras to detect the game process on the tabletop comprehensively and rapidly and reduce the condition that a subsequent real-time supervision process is affected by missing of proper images due to excessively quick actions.

Real-time video shooting may be performed on the game table using a camera component arranged above the game table, and a shot video is sent to the edge computing node. Therefore, the edge computing node may perform extraction on the received video, and perform sampling based on an extracted video sequence of the game table when the game prop operating stage is entered to obtain an image frame sequence to be detected.

The parsing layer is configured in the edge computing node to execute recognition and detection of the image frame sequence in advance and transmit the detection and recognition result of each frame of image to the service layer through a message queue, so that the service layer may perform real-time analysis processing on the detection and recognition result to supervise whether a participant of the game breaks a game rule in real time in the game process.

In S320, original token information of each region is acquired through the cache layer.

Here, the original token information is information, determined by the parsing layer in response to recognizing that the game controller operates the game prop for the first time and stored in the cache layer, of the token placed in each region. The original token information includes, but not limited to, the amount, value, type, and confidence of the token.

Before the game prop operating stage is entered, the original token information is stored through the cache layer for subsequently judging whether a person changed the original token in the game prop operating stage based on the original token information to achieve a purpose of supervising the game process.

It is to be noted that, after the game is entered, all the gamers participating in the game place tokens, and then the original token information may be stored.

In a possible implementation mode, the parsing layer determines the original token placed by at least one gamer in each region in response to recognizing that the game controller operates the game prop for the first time based on the detection recognition result, and stores the original token information to the cache layer. In another possible implementation mode, the parsing layer pushes the original token information to the cache layer immediately after recognizing that all the gamers have completed placing the original token for the service layer to acquire directly after the game prop operating stage is entered.

In S330, the target region where the token is changed in the multiple regions is determined based on the recognition result of each frame of image and the original token information of each region.

Here, the recognition result of each frame of image is obtained after each frame of image in the image frame sequence is recognized through a trained target detection model and behavior recognition model. The detection and recognition result may include a recognized hand action and a position, and may further include recognized token in each region on the game table. For example, there is a pile of tokens in region A, and there are two piles of tokens in region B. The recognized present token information of each region may be compared with the original token information of the corresponding region to determine the target region where the original token is changed in the multiple regions.

Accordingly, the parsing layer is configured in the edge computing node to execute recognition and detection of the image frame sequence in advance and transmit the recognition result to the service layer. Meanwhile, the original token in each region is stored through the cache layer. Therefore, the service layer may perform real-time analysis processing on the detection and recognition result to supervise whether the participant of the game breaks the game rule in real time in the game process.

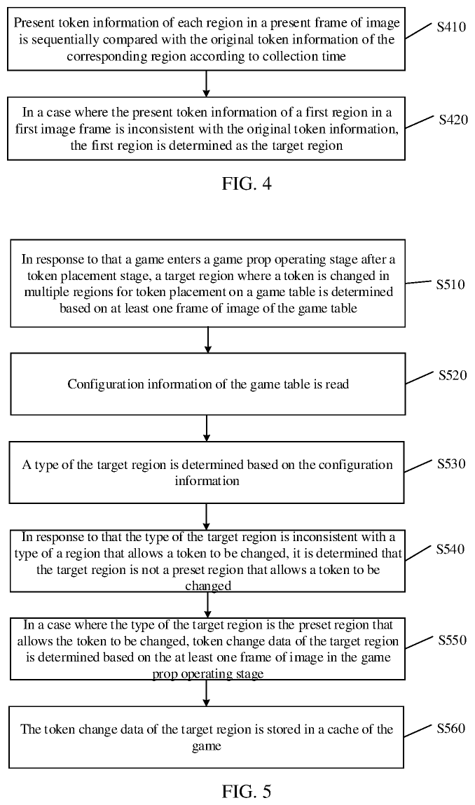

FIG. 4 is a flowchart of a method for detecting tokens on a game table according to an embodiment of the application. As shown in FIG. 4, the method includes the following operations.

In S410, present token information of each region in a present frame of image is sequentially compared with the original token information of the corresponding region according to collection time.

Here, the present frame of image is an unprocessed image corresponding to earliest collection time in the image frame sequence to be detected, for ensuring that the present token information of a certain region is found different from the original token information of the region.

It is to be noted that the service layer consumes and stores, in a sliding count window, the detection and recognition result of each frame in the message queue, and when the amount of information in the window reaches a sliding amount, a right edge of the window moves rightwards. That is, when data of a first frame, second frame, third frame, fourth frame, and fifth frame is sequentially arranged in the window according to collection time, the data of the first frame is pushed out in response to storage of data of a sixth frame in the window to perform a related service logic, and in such case, data in the window is the data of the second frame to the sixth frame.

The image frame sequence that is collected in real time may be recognized and parsed to obtain the original token information of each target region. Then, the original token information and corresponding regional information are stored in a cache or another file system. Therefore, the original token information corresponding to each target region may be read directly to implement real-time comparison between the present token information of each region in the present frame of image and the original token information of the corresponding region.

In S420, in a case where the present token information of a first region in a first image frame is inconsistent with the original token information, the first region is determined as the target region.

Here, the service layer compares the original token information of each region and the present token information of the corresponding region. In a case where the two pieces of information are inconsistent, it is determined that the original token information of each region is kept unchanged in the game prop operating stage. In a case where the present token information of the first region in the first image frame is inconsistent with the original token information, it is determined that the original token information of the first region is changed in the game prop operating stage, and thus the first region is determined as the target region.

That the present token information of the first region in the first image frame is inconsistent with the original token information includes at least one of the following: a present token amount of the first region is larger than an original token amount; a present token value of the first region is higher than an original token value; the present token amount of the first region is smaller than the original token amount; or the present token value of the first region is lower than the original token value. As such, if the original token amount and/or original token value of the first region increase/increases, it indicates that a person places a new token in the first region. If the original token amount and/or original token value of the first region decrease/decreases, it indicates that a person removes the token in the first region. Therefore, the first region is required to be tracked as the target region to determine whether a person violates the game rule.

In some implementation modes, the amount of tokens is represented by a pile number, each pile being formed by stacking a fixed or unfixed amount of tokens. In some implementation modes, the value of the token is represented by a face value, namely a specific numerical face value is set on a surface of the token. In some other implementation modes, the value of the token may also be correlated with a color thereof. For example, a face value of a red token is 100, and a face value of a blue token is 50. In some implementation modes, the type of the token includes a type for members, a type for non-members, etc. In some implementation modes, the confidence of the token represents the reliability of the recognition result. For example, if the confidence of the token is −1, it indicates that the recognition result of the token is unreliable and not suitable for subsequent comparison or analysis.

Exemplarily, gamer A places two piles of tokens in a specific region as original token information, while three piles of tokens are detected in the specific region in the present frame of image. Therefore, it is determined that one pile is added based on original token in the specific region in the game prop operating stage, and it indicates that a person violates the rule and continues placing tokens in the specific region.

Exemplarily, gamer B places a token of which a value is 50 in a specific region as original token, while a token of which a value is 100 is detected in the specific region in the present frame of image. Therefore, it is determined that the amount of the original token in the specific region increases in the game prop operating stage, and it indicates that a person violates the rule and continues placing tokens in the specific region.

The present token information of each region in the present frame of image may be sequentially compared with the original token information of the corresponding region to timely determine the target region where the original token is changed. As such, an exception in the game prop operating stage may be monitored timely and accurately, the loss of the gamer or the game place may be reduced, and the purpose of supervising the game process may be achieved.

FIG. 5 is a flowchart of a method for detecting tokens on a game table according to an embodiment of the application. As shown in FIG. 5, the method includes the following operations.

In S510, in response to that a game enters a game prop operating stage after a token placement stage, a target region where a token is changed in multiple regions for token placement on a game table is determined based on at least one frame of image of the game table.

Here, the token in each region is configured to perform payout according to an operation result of a game prop in a payout stage of the game.

In S520, configuration information of the game table is read.

Here, the configuration information includes type information of each region on the game table.

It is to be noted that application service running on the game table is usually required to be adapted to different game rules and hardware using different configuration information. The configuration information usually includes a configuration parameter of the game table of a game place, as well as a region type, token type, etc., of the game table. Application software includes all latest configuration information in a new-version package. If an edge computing node installs a latest version, resource files of all scenes have been included, and a purpose may be achieved by using corresponding resource files for different scenes.

During implementation, an application scene of the present game table is detected in real time to update the configuration information in real time to realize a service function according to a service requirement.

In S530, a type of the target region is determined based on the configuration information.

Here, the configuration information of the game table is read to determine the type of the target region, thereby further performing different processing for different types of target regions.

Corresponding to different application scenes of the game table, the type of the target region may include a first-type and a second-type. Changing a token in the first-type region in the game prop operating stage may not affect payout in the game. The token in the second-type region is a basis for payout in the game, and the token in the second-type region is required to be kept unchanged after a token placement state is ended until payout in the game is completed. The first-type region includes a player insured region and a banker insured region. The second-type region includes a player region and a banker region.

In S540, in response to that the type of the target region is inconsistent with a type of a region that allows a token to be changed, it is determined that the target region is not a preset region that allows a token to be changed.

Here, the preset type represents that the target region is a region that allows a person to change the token in the game prop operating stage. For example, it is set that the preset type is the type of the first-type region such that a gamer may continue placing tokens in the target region or remove the token in the game prop operating stage.

Here, a management system is in communication connection with the edge computing node. A notification message is configured to instruct not to send alarm information to the target region in response to detecting that original token in the target region is changed.

In some embodiments, the method further includes that: in a case where the target region is the preset region that allows the token to be changed, a notification message is sent to a management system of the game table. The management system is in communication connection with the edge computing node. The notification message is configured to instruct not to send the alarm information to the target region in response to detecting that the token in the target region is changed.

In S550, in a case where the type of the target region is the preset region that allows the token to be changed, token change data of the target region is determined based on the at least one frame of image in the game prop operating stage.

Here, the token change data of the target region includes a token added to the target region in the game prop operating stage or a token removed from the target region in the game prop operating stage. In a case where the present token is less than the original token, the token, except the present token, in the original token is determined as the removed token. In a case where the present token is more than the original token, the token, except the original token, in the present token is determined as the added token.

In some embodiments, before the token change data of the target region is stored in a cache of the game, the method further includes that: identifier information of a token placer correlated with the token change data is determined based on the at least one frame of image in the game prop operating stage. The identifier information may be an identity of the token placer, i.e., an operation object, and is usually obtained by processing through a corresponding correlation algorithm module in a cache layer.

The operation that the token change data of the target region is stored in the cache of the game includes that: the token change data of the target region and the identifier information are correlatively stored in the cache of the game to update token information correlated with the identifier information in the cache. As such, the token change data and the identifier information of the token placer are correlatively stored in the cache for subsequent further analysis of a service logic to improve the detection efficiency.

In some implementation modes, there may be one or more target regions where the original token is changed in the present frame of image, and thus the token change data of the target region may further include corresponding regional information.

Exemplarily, gamer A places two piles of tokens in region X as the original token, while three piles of token are detected in region X in the present frame. Therefore, it is determined that one pile is added based on the original token in region X in the game prop operating stage, and it indicates that region X is a target region and the token change data is the pile of tokens added by gamer A.

In S560, the token change data of the target region is stored in a cache of the game.

Here, the added token or removed token of the target region and related information are stored in the cache of the game for payout calculation in a subsequent payout stage.

In the embodiment of the application, when the original token in a target region of the preset type is changed, a notification message is sent to the management system to avoid alarming and reduce unnecessary alarming mistakenly triggered by a normal behavioral operation over the target region of the preset type. Meanwhile, the token change data of the target region is stored to facilitate subsequent payout calculation when a game result comes out.

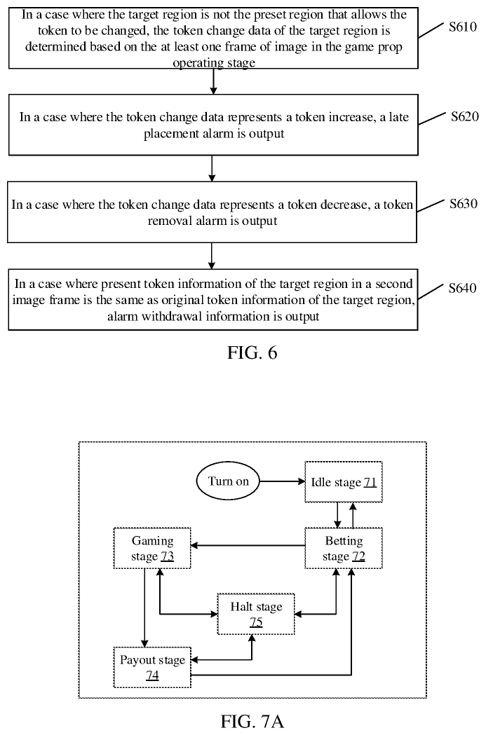

FIG. 6 is a flowchart of a method for detecting tokens on a game table according to an embodiment of the application. As shown in FIG. 6, the method includes the following operations.

In S610, in a case where the target region is not the preset region that allows the token to be changed, the token change data of the target region is determined based on the at least one frame of image in the game prop operating stage.

In S620, in a case where the token change data represents a token increase, a late placement alarm is output.

Here, for the target region where the amount of the original token increases, late placement alarm information is output to indicate that a person continues placing a new token in the target region in the game prop operating stage, thereby achieving an effect of supervising irregular behaviors in a game prop operating process.

In some implementation modes, the original token in some target regions may be changed for reasons such as relatively dark shooting light or occlusions rather than human factors, and consequently, incorrect recognition results may be obtained to cause misjudgments. In the embodiment of the application, after the target region in the present frame is detected, whether the target region still appears in subsequently collected image frames is continuously tracked, and whether a first frame number of frames where the target region continuously appears reaches a first threshold is determined for further judgment.

In S630, in a case where the token change data represents a token decrease, a token removal alarm is output.

Here, for the target region where the amount of the original token decreases, token removal alarm information is output to indicate that a person removes the token in the target region in the game prop operating stage, thereby achieving the effect of supervising irregular behaviors in the game prop operating process.

Through S620 to S630, different target alarm information may be output for different conditions of increase or decrease of the original token to indicate alarming reasons. For example, in some implementation modes, a region where the amount of original token increases is determined as a first target region, and late placement alarm information is output as target alarm information. In some other implementation modes, a region where the amount of original token decreases is determined as a second target region, and token removal alarm information is output as target alarm information.

In S640, in a case where present token information of the target region in a second image frame is the same as original token information of the target region, alarm withdrawal information is output.

Here, the second image frame is an image frame of which collection time is later than the first image frame in the image frame sequence.

The original token in the target region is stored through the cache layer. Then, whether the original token in the target region is recovered is determined based on whether the original token information is consistent with the present token information of the target region in the second image frame.

It is to be noted that, in the embodiment of the application, the target alarm information may be output only when the original token is changed in the game prop operating stage. The alarm withdrawal information may be output in the game prop operating stage, or may be output in the payout stage or another stage after the game prop operating stage. The alarm withdrawal information is output as long as the removed original token is placed back in the target region or the added token is removed.

In some implementation modes, in a case where the continuous frame number of the second image frame reaches a second threshold, the alarm withdrawal information is output. In such a manner, it is determined that the number of continuous image frames where the original token is recovered reaches the second threshold, so that misjudgments caused by relatively dark light, occlusions, etc., in individual image frames may be reduced, and whether the game prop operating process is regular is supervised effectively.

In some implementation modes, the second threshold is less than the first threshold. In such case, an alarm may be given more timely in response to detecting that the original token is changed, and it may be determined accurately that the original token is actually recovered when the alarm is withdrawn, so that the whole supervision process is more efficient and feasible.

In the embodiment of the application, different alarm information may be output for original token changes caused by different operations to achieve the effect of supervising various irregular behaviors in the game prop operating process effectively. In addition, after the target alarm information is output, the original token in the target region is stored through the cache layer, and it is determined, based on whether a candidate token in the target region in a subsequent candidate frame sequence is consistent with the corresponding original token, that the original token in the target region is covered. In such case, the alarm withdrawal information may be output, to ensure that the game may be played normally.

The method for detecting tokens on a game table will be described below in combination with a specific embodiment. However, it is to be noted that the specific embodiment is only for describing the application better and does not form improper limits to the application.

The method for detecting tokens on a game table in the embodiments of the application may be applied to a casino scene. In the casino scene, the gamer mentioned anywhere in the embodiments of the application may include a player or a banker, the game controller mentioned anywhere in the embodiments of the application may refer to a dealer, the game table mentioned anywhere in the embodiments of the application may refer to a gambling table, the token mentioned anywhere in the embodiments of the application may include chip, the region mentioned anywhere in the embodiments of the application may refer to a betting region on the game table, and the management system mentioned anywhere in the embodiments of the application may refer to a CMS.

A conventional casino is relatively low in intelligence degree, control of a game process and payment depends on the dealer only, and it is unlikely to track and judge irregular actions. The embodiment of the application proposes deployment of an intelligent casino scene based on a computer vision technology, and a cloud device and multiple extensible AI nodes are arranged. Each AI node includes an edge computing node, which runs a set of intelligent casino service to control the overall progress of a game on a game table (also called a gaming table), implement effective tracking and alarming on irregular actions of the dealer or gamers and reduce the human cost on one hand, and on the other hand, to automatically count the overall game condition (incomes and the number of tables in use) of the casino to assist the manager in making decisions.

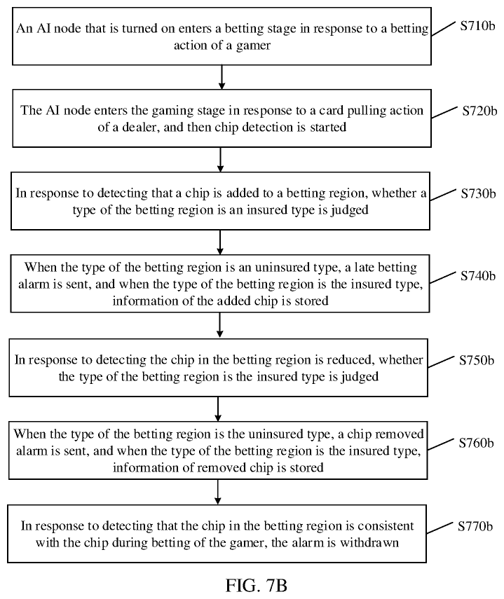

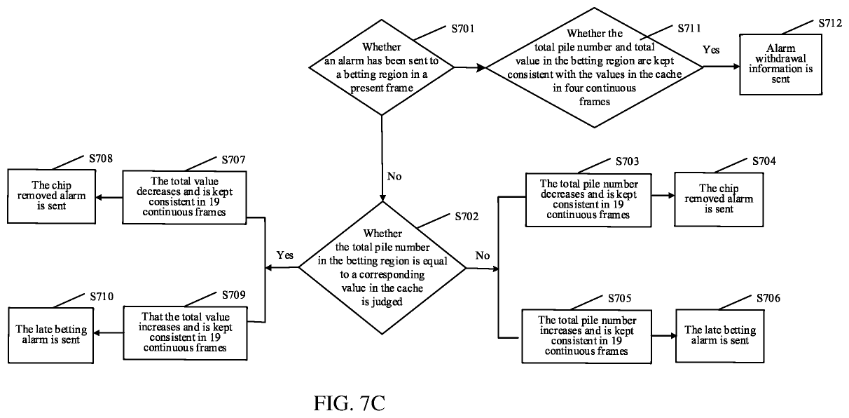

In the embodiment of the application, descriptions are made taking Baccarat (a card game) as an example. FIG. 7A is a state flowchart of a game process according to an embodiment of the application. As shown in FIG. 7A, according to a game process, the AI node monitoring a game table is divided into five stages, i.e., an idle stage 71 (idle), a betting stage 72 (betting), a gaming stage 73 (gaming), a payout stage 74 (payout), and a halt stage 75 (halt). The idle stage 71 is a state after a service system is powered on, and in this state, the system may not send any service data or alarm information to another intelligent system of the casino. The betting stage 72 is equivalent to the abovementioned token placement stage, and this stage is a stage that all garners place corresponding chips in betting regions. The gaming stage 73 is equivalent to the abovementioned prop operating stage, such as a stage that the dealer deals cards, and in this stage, all the garners are not allowed to bet. The payout stage 74 is a stage that a result of a round of game has come out and the dealer starts paying or collecting chips. The halt stage 75 is a state that the service system enters when a card dealing operation of the dealer does not follow the rule of Baccarat or the specification of the casino. All the betting stage 72, the gaming stage 73, and the payout stage 74 may skip to the halt stage 75 due to irregular operations. In the halt stage 75, objects on the table may still be detected and recognized, some service processing may be performed, and service data or alarm information may be sent to the other intelligent system of the casino.

The dealer draws four to six cards from three to eight decks of shuffled cards, and a win-lose result may be obtained according to a rule. The win-lose result is divided into: the player wins, the bank wins, tie, etc. Gained or paid money of the garner and the casino is calculated according to the win-lose result of each round of game, payout ratios in different scenes, and whether to take commissions. There are certain rules for card dealing of the dealer and peeking of the garner, and if the rules are broken, the monitoring system needs to give an alarm.

After the dealer pulls the cards, any person is not allowed to bet on a betting region or remove the chip in the betting region. For detecting whether the garner or the dealer follows the game rule, image recognition is performed on the chips on the table, the garner, and the dealer through the AI nodes to obtain inferred chip increment data (equivalent to the original token information). Therefore, whether to send an alarm and withdraw the alarm is judged according to the chip increment data.

In the embodiment of the application, an event occurring on the table is detected using at least one camera, and is converted into computer information for transmission to the parsing layer to perform detection and recognition, and finally, the service layer acquires a detection and recognition result for further analysis processing.

When the dealer pulls the cards, for preventing the garner or the dealer from contacting the chips in the betting region, in response to detecting a chip data change of the betting region, configuration information is required to be read to judge whether a type of the present betting region is an insured type. If the type is an uninsured type, an alarm is required to be sent timely, and in such case, the AI node skips from the gaming stage 73 to the halt stage 75. If the type is the insured type, no alarm is sent. Therefore, whether the dealer and the garner follow the game rule is supervised, and the loss of the casino is reduced. For example, when the garner or the dealer adds a pile of chips to the betting region, the AI node may send a late betting alarm to make a prompt that a person is adding chips to the betting region. When the added pile of chips are removed, the alarm may be withdrawn automatically.

FIG. 7B is a logic flowchart of a method for detecting tokens on a game table according to an embodiment of the application.

In S710b, an AI node that is turned on enters a betting stage in response to a betting action of a gamer.

In the betting stage, all gamers place specific numbers of piles of chips in corresponding betting regions to complete betting.

In S720b, the AI node enters the gaming stage in response to a card pulling action of a dealer, and then chip detection is started.

Here, the gaming stage 73 is entered after betting. In this stage, the dealer pulls cards according to a game rule, and a win-lose result is judged according to the cards pulled by the dealer. Card pulling may also be called card dealing. When the dealer starts card pulling, namely deals a first card, chip detection (no more bet) is started. Chip detection is no more bet testing usually used in a casino.

When the dealer is prepared for card pulling, chip increment data inferred by the parsing layer is cached to detect whether the amount of the chips in the betting region increases or decreases in the gaming stage 73 by comparison based on the cached chip increment data.

In S730b, in response to detecting that a chip is added to a betting region, whether a type of the betting region is an insured type is judged.

Here, a configuration file is read to judge whether the type of the betting region is the insured type.

In S740b, when the type of the betting region is an uninsured type, a late betting alarm is sent, and when the type of the betting region is the insured type, information of the added chip is stored.

Here, late betting refers to betting after the playing cards are dealt in the gaming stage, and is an irregular betting manner.

Therefore, when the gamer or the dealer adds a chip to a betting region of the uninsured type, the late betting alarm (equivalent to a late placement alarm) may be sent may be sent to make a prompt that a person is adding the chip to the betting region. When the gamer or the dealer adds a chip to a betting region of the insured type, information of the added chip is stored in a cache of the game for payout calculation in a subsequent payout stage.

In S750b, in response to detecting that the chip in the betting region is reduced, whether the type of the betting region is the insured type is judged.

In S760b, when the type of the betting region is the uninsured type, a chip removed alarm is sent, and when the type of the betting region is the insured type, information of removed chip is stored.

Here, chip removed refers to that the chip in the betting region is removed after the cards are dealt in the gaming stage 73, and is an irregular operation manner.

Therefore, when the gamer or the dealer removes a chip in the betting region of the uninsured type, the chip removed alarm (equivalent to a token removed alarm) may be sent to make a prompt that a person is removing the chip from the betting region. If the type of the present betting region is the insured type, the information of the removed chip is stored in the cache of the game for payout calculation in the subsequent payout stage.

In S770b, in response to detecting that the chip in the betting region is consistent with the chip during betting of the gamer, the alarm is withdrawn.

After the alarm is sent to the betting region, the alarm may be withdrawn automatically as long as the added chip are removed or the removed chip are placed back. Therefore, manual processing may be reduced, and the management efficiency of the casino may be improved.

The parsing layer and the service layer are configured in the AI node provided in the embodiment of the application. The parsing layer includes multiple algorithm models, such as a target detection algorithm, a recognition algorithm, and a correlation algorithm, which are configured to perform image recognition on a video sequence collected by a specific camera (arranged above the game table) to obtain a detection and recognition result of each frame of image. The service layer acquires the detection and recognition result from the parsing layer for service logic processing, and interacts with an internal system of the casino. In a chip detection process, the parsing layer recognizes each frame of image in the image frame sequence, and inputs the detection and recognition result of each frame of image to a message queue, and the service layer acquires the detection and recognition result of each frame of image from the message queue.

The chip detection process is executed by the service layer. The service layer extracts each frame from the message queue, and compares chip data of each betting region in a present frame with chip data, stored in the cache, of the corresponding region. The chip data may include a chip pile number and/or a chip value. If a comparison result indicates that the chip data of a certain betting region is changed and it is further determined that this change of the chip data of the betting region is kept in a plurality of continuous frames of images, an alarm is sent to the betting region.

FIG. 7C is a flowchart of chip detection in a gaming stage according to an embodiment of the application. The total pile number represents the total pile number of the chips in each betting region, and the total value represents a total value of the chips in each betting region. As shown in FIG. 7C, the detection flow includes the following operations.

In S701, whether an alarm has been sent to a betting region in a present frame is judged.

Here, judgment is made for each betting region in the present frame. The condition that the alarm has been sent to the betting region may refer to that a chip removed alarm (equivalent to the token removed alarm) has been sent, or that a late betting alarm (equivalent to the late placement alarm) has been sent.

If no alarm has been sent to the betting region, S703 to S710 are executed. If the alarm has been sent to the betting region, S711 to S712 are executed.

In S702, whether the total pile number in the betting region is equal to a corresponding value in the cache is judged.

If the total pile number of the chips is unequal to the value in the cache, S703 to S706 are executed. If the total pile number of the chips is equal to the value in the cache, S707 to S710 are executed.

In S703, it is determined that the total pile number decreases and is kept consistent in 19 continuous frames.

In S704, the chip removed alarm is sent.

In S705, it is determined that the total pile number increases and is kept consistent in 19 continuous frames.

In S706, the late betting alarm is sent.

In S707, it is determined that the total value decreases and is kept consistent in 19 continuous frames.

In S708, the chip removed alarm is sent.

In S709, it is determined that the total value increases and is kept consistent in 19 continuous frames.

In S710, the late betting alarm is sent.

In S711, whether the total pile number and total value in the betting region are kept consistent with the values in the cache in four continuous frames is judged.

In S712, alarm withdrawal information is sent.

If it is determined that the total value of the chips in the betting region in the present frame is kept unchanged, the next frame in the message queue is continued to be processed according to S701 to S712.

In the embodiment of the application, the AI node may detect whether the chips in the betting region are changed after card pulling of the dealer according to the chip increment data inferred by the parsing layer, and when the chips in the betting region are changed, the alarm may be sent immediately, so that the management efficiency of the game place is improved, and the loss of the game place and the gamer is reduced. In addition, after the alarm is sent, the alarm may be withdrawn automatically as long as the added chip are removed or the removed chip are placed back, so that manual processing is reduced.

Based on the abovementioned embodiments, the embodiments of the application also provide an apparatus for detecting tokens on a game table. Each module of the apparatus and each submodule and unit of each module may be implemented through a processor in an edge computing node, and of course, may also be implemented through a specific logic circuit. In an implementation process, the processor may be a Central Processing Unit (CPU), a Micro Processing Unit (MPU), a Digital Signal Processor (DSP), a Field Programmable Gate Array (FPGA), etc.

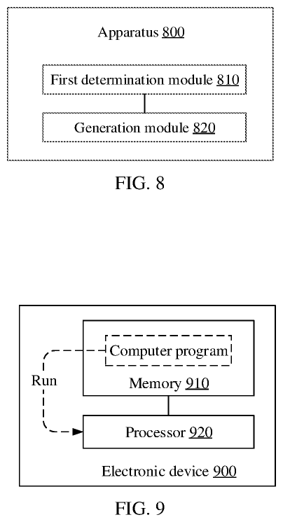

FIG. 8 is a composition structure diagram of an apparatus for detecting tokens on a game table according to an embodiment of the application. As shown in FIG. 8, the apparatus 800 includes a first determination module 810 and a generation module 820.

The first determination module 810 is configured to, in response to that a game enters a game prop operating stage after a token placement stage, determine a target region where token is changed in multiple regions for token placement on a game table based on at least one frame of image of the game table, the token in each region being configured to perform payout according to an operation result of a game prop in a payout stage of the game.

The generation module 820 is configured to, in a case where the target region is not a preset region that allows the token to be changed, generate alarm information for the target region.

In some embodiments, the first determination module may include a first acquisition unit, a second acquisition unit, and a first determination unit.

The first acquisition unit is configured to, in response to that the game enters the game prop operating stage after the token placement stage, acquire, through a parsing layer, a recognition result obtained after each frame of image in an image frame sequence collected in the game prop operating stage is recognized.

The second acquisition unit is configured to acquire original token information of each region through a cache layer, the original token information being information, determined by the parsing layer in response to recognizing that a game controller operates a game prop for the first time and stored in the cache layer, of the token placed in each region.

The first determination unit is configured to determine the target region where the token is changed in the multiple regions based on the recognition result of each frame of image and the original token information of each region.

In some embodiments, the recognition result includes present token information of each region in each frame of image. The determination unit includes a comparison subunit and a determination subunit. The comparison subunit is configured to sequentially compare the present token information of each region in a present frame of image with the original token information of the corresponding region according to collection time. The determination subunit is configured to, in a case where the present token information of a first region in a first image frame is inconsistent with the original token information, determine the first region as the target region.

In some embodiments, that the present token information of the first region in the first image frame is inconsistent with the original token information includes at least one of the following.

A present token amount of the first region is larger than an original token amount.

A present token value of the first region is higher than an original token value.

The present token amount of the first region is smaller than the original token amount.

The present token value of the first region is lower than the original token value.

In some embodiments, the apparatus further includes a reading module, a second determination module, and a third determination module. The reading module is configured to read configuration information of the game table, the configuration information including type information of each region on the game table. The second determination module is configured to determine a type of the target region based on the configuration information. The third determination module is configured to, in response to that the type of the target region is inconsistent with a type of the region that allows the token to be changed, determine that the target region is not the preset region that allows the token to be changed.

In some embodiments, the apparatus further includes a sending module, configured to, in a case where the target region is the preset region that allows the token to be changed, send a notification message to a management system of the game table. The management system is in communication connection with an edge computing node. The notification message is configured to instruct not to send the alarm information to the target region in response to detecting that the token in the target region is changed.

In some embodiments, the apparatus further includes a fourth determination module and a storage module. The fourth determination module is configured to, in a case where the target region is the preset region that allows the token to be changed, determine token change data of the target region based on the at least one frame of image in the game prop operating stage. The storage module is configured to store the token change data of the target region in a cache of the game.

In some embodiments, the apparatus further includes a fifth determination module, configured to determine identifier information of a token placer correlated with the token change data based on the at least one frame of image in the game prop operating stage.

The storage module is further configured to correlatively store the token change data of the target region and the identifier information in the cache of the game to update token information correlated with the identifier information in the cache.

In some embodiments, the generation module includes a second determination unit and an output unit. The second determination unit is configured to, in a case where the type of the target region is not the preset region that allows the token to be changed, determine the token change data of the target region based on the at least one frame of image in the game prop operating stage. The output unit is configured to, in a case where the token change data represents a token increase, output a late placement alarm, and in a case where the token change data represents a token decrease, output a token removed alarm.

In some embodiments, the apparatus further includes the output unit, further configured to, in a case where token information of the target region in a second image frame is the same as original token information of the target region, output alarm withdrawal information. The second image frame is an image frame of which collection time is later than the first image frame in the image frame sequence.

It is to be pointed out that descriptions about the above apparatus embodiment are similar to descriptions about the method embodiment and beneficial effects similar to those of the method embodiment are achieved. Technical details undisclosed in the apparatus embodiments of the application may be understood with reference to the descriptions about the method embodiments of the application.

It is to be noted that, in the embodiments of the application, when implemented in form of a software function module and sold or used as an independent product, the method for detecting tokens on a game table may also be stored in a computer-readable storage medium. Based on such an understanding, the technical solutions of the embodiments of the application substantially or parts making contributions to the related art may be embodied in form of software product. The computer software product is stored in a storage medium, including a plurality of instructions configured to enable an electronic device (which may be a smart phone with a camera, a tablet computer, etc.) to execute all or part of the method in each embodiment of the application. The storage medium includes various media capable of storing program codes such as a U disk, a mobile hard disk, a Read Only Memory (ROM), a magnetic disk, or an optical disk. Therefore, the embodiments of the application are not limited to any specific hardware and software combination.

Correspondingly, the embodiments of the application provide a computer-readable storage medium, in which a computer program is stored. The computer program is executed by a processor to implement the steps in the method for detecting tokens on a game table in any abovementioned embodiment. Correspondingly, there is also provided a chip in the embodiments of the application. The chip includes a programmable logic circuit and/or a program instruction. The chip, when running, is configured to implement the steps in the method for detecting tokens on a game table in any abovementioned embodiment. Correspondingly, there is also provided a computer program product in the embodiments of the application. The computer program product, when executed by a processor of an electronic device, is configured to implement the steps in the method for detecting tokens on a game table in any abovementioned embodiment.

Based on the same technical concept, the embodiments of the application provide an electronic device, which is configured to implement a method recorded in the method embodiments for detecting tokens on a game table. FIG. 9 is a schematic diagram of hardware entities of an electronic device according to an embodiment of the application. As shown in FIG. 9, the electronic device 900 includes a memory 910 and a processor 920. The memory 910 stores a computer program capable of running in the processor 920. The processor 920 executes the program to implement the steps in any method for detecting tokens on a game table in the embodiments of the application.

The memory 910 is configured to store an instruction and application executable for the processor 920, may also cache data (for example, image data, video data, voice communication data, and video communication data) to be processed or having been processed by the processor 920 and each module in the electronic device 400, and may be implemented through a flash or a Random Access Memory (RAM).

The processor 920 executes the program to implement the steps of any abovementioned method for detecting tokens on a game table. The processor 920 usually controls overall operations of the electronic device 900.

The processor may be at least one of an ASIC, a DSP, a Digital Signal Processing Device (DSPD), a Programmable Logic Device (PLD), an FPGA, a CPU, a controller, a microcontroller, or an MPU. It can be understood that other electronic devices may also be configured to realize functions of the processor, and no specific limits are made in the embodiments of the application.

The computer storage medium/memory may be a memory such as a ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any electronic device including one or any combination of the abovementioned memories, such as a mobile phone, a computer, a tablet device, and a personal digital assistant.

It is to be pointed out here that the above descriptions about the storage medium and device embodiments are similar to the descriptions about the method embodiment, and beneficial effects similar to those of the method embodiment are achieved. Technical details undisclosed in the storage medium and device embodiment of the application are understood with reference to the descriptions about the method embodiment of the application.

It is to be understood that “one embodiment” and “an embodiment” mentioned in the whole specification mean that specific features, structures or characteristics related to the embodiment is included in at least one embodiment of the application. Therefore, “in one embodiment” or “in an embodiment” mentioned throughout the specification does not always refer to the same embodiment. In addition, these specific features, structures or characteristics may be combined in one or more embodiments freely as appropriate. It is to be understood that, in each embodiment of the application, a magnitude of a sequence number of each process does not mean an execution sequence and the execution sequence of each process should be determined by its function and an internal logic and should not form any limit to an implementation process of the embodiments of the application. The sequence numbers of the embodiments of the application are adopted not to represent superiority-inferiority of the embodiments but only for description.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an” does not exclude existence of the same other elements in a process, method, object or device including the element.

In some embodiments provided by the application, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments of the application.

In addition, each functional unit in each embodiment of the application may be integrated into a processing unit, each unit may also serve as an independent unit and two or more than two units may also be integrated into a unit. The integrated unit may be implemented in a hardware form and may also be implemented in form of hardware and software functional unit.

Or, when being implemented in form of software functional module and sold or used as an independent product, the integrated unit of the application may also be stored in a computer-readable storage medium. Based on such an understanding, the technical solutions of the embodiments of the application substantially or parts making contributions to the related art may be embodied in form of a software product. The computer software product is stored in a storage medium, including a plurality of instructions configured to enable an automatic test line of a device to execute all or part of the method in each embodiment of the application. The storage medium includes: various media capable of storing program codes such as a mobile hard disk, a ROM, a magnetic disk, or an optical disc.

The methods disclosed in some method embodiments provided in the application may be freely combined without conflicts to obtain new method embodiments.

The characteristics disclosed in some method or device embodiments provided in the application may be freely combined without conflicts to obtain new method embodiments or device embodiments.

The above is only the implementation mode of the application and not intended to limit the scope of protection of the application. Any variations or replacements apparent to those skilled in the art within the technical scope disclosed by the application shall fall within the scope of protection of the application. Therefore, the scope of protection of the application shall be subject to the scope of protection of the claims.

1. A method for detecting tokens on a game table, comprising:
in response to that a game enters a game prop operating stage after a token placement stage, determining a target region where a token is changed in a plurality of regions for token placement on a game table based on at least one frame of image of the game table, the token in each region being configured to perform payout according to an operation result of a game prop in a payout stage of the game; and
in a case where the target region is not a preset region that allows the token to be changed, generating alarm information for the target region.

2. The method of claim 1, applied to a service layer of an edge computing node, the edge computing node further comprising a parsing layer and a cache layer, wherein
determining the target region where the token is changed in the plurality of regions for token placement on the game table based on the at least one frame of image of the game table comprises:
acquiring, through the parsing layer, a recognition result obtained after each frame of image in an image frame sequence collected in the game prop operating stage is recognized;
acquiring original token information of the each region through a cache layer, the original token information being information, determined by the parsing layer in response to recognizing that a game controller operates a game prop for the first time and stored in the cache layer, of the token placed in the each region; and
determining the target region where the token is changed in the plurality of regions based on the recognition result of the each frame of image and the original token information of the each region.

3. The method of claim 2, wherein the recognition result comprises present token information of the each region in the each frame of image; and determining the target region where the token is changed in the plurality of regions based on the recognition result of the each frame of image and the original token information of the each region comprises:
sequentially comparing the present token information of the each region in a present frame of image with the original token information of the corresponding region according to collection time, and
in a case where the present token information of a first region in a first image frame is inconsistent with the original token information, determining the first region as the target region.

4. The method of claim 3, wherein that the present token information of the first region in the first image frame is inconsistent with the original token information comprises at least one of:
a present token amount of the first region is larger than an original token amount;
a present token value of the first region is higher than an original token value;
the present token amount of the first region is smaller than the original token amount; or
the present token value of the first region is lower than the original token value.

5. The method of claim 3, further comprising:
reading configuration information of the game table, the configuration information comprising type information of the each region on the game table;
determining a type of the target region based on the configuration information; and
in response to that the type of the target region is inconsistent with a type of the region that allows the token to be changed, determining that the target region is not the preset region that allows the token to be changed.

6. The method of claim 1, further comprising:
in a case where the target region is the preset region that allows the token to be changed, sending a notification message to a management system of the game table,
wherein the management system is in communication connection with an edge computing node; and the notification message is configured to instruct not to send the alarm information to the target region in response to detecting that the token in the target region is changed.

7. The method of claim 3, further comprising:
in a case where the target region is the preset region that allows the token to be changed, determining token change data of the target region based on the at least one frame of image in the game prop operating stage; and
storing the token change data of the target region in a cache of the game.

8. The method of claim 6, further comprising:
in a case where the target region is the preset region that allows the token to be changed, determining token change data of the target region based on the at least one frame of image in the game prop operating stage; and
storing the token change data of the target region in a cache of the game.

9. The method of claim 7, before storing the token change data of the target region in the cache of the game, further comprising:
determining identifier information of a token placer correlated with the token change data based on the at least one frame of image in the game prop operating stage, wherein
storing the token change data of the target region in the cache of the game comprises:
correlatively storing the token change data of the target region and the identifier information in the cache of the game to update token information correlated with the identifier information in the cache.

10. The method of claim 3, wherein generating the alarm information for the target region in a case where the target region is not the preset region that allows the token to be changed comprises:
in a case where the target region is not the preset region that allows the token to be changed, determining token change data of the target region based on the at least one frame of image in the game prop operating stage;
in a case where the token change data represents a token increase, outputting a late placement alarm; and
in a case where the token change data represents a token decrease, outputting a token removal alarm.

11. The method of claim 10, further comprising:
in a case where token information of the target region in a second image frame is the same as original token information of the target region, outputting alarm withdrawal information, the second image frame being an image frame of which collection time is later than the first image frame in the image frame sequence.

12. An electronic device, comprising a memory and a processor, wherein the memory stores a computer program capable of running in the processor, and when executing the computer program, the processor is configured to:
in response to that a game enters a game prop operating stage after a token placement stage, determine a target region where a token is changed in a plurality of regions for token placement on a game table based on at least one frame of image of the game table, the token in each region being configured to perform payout according to an operation result of a game prop in a payout stage of the game; and
in a case where the target region is not a preset region that allows the token to be changed, generate alarm information for the target region.

13. The electronic device of claim 12, configured to implement a service layer of an edge computing node, the edge computing node further comprising a parsing layer and a cache layer,
wherein the processor is configured to:
acquire, through the parsing layer, a recognition result obtained after each frame of image in an image frame sequence collected in the game prop operating stage is recognized;
acquire original token information of the each region through a cache layer, the original token information being information, determined by the parsing layer in response to recognizing that a game controller operates a game prop for the first time and stored in the cache layer, of the token placed in the each region; and
determine the target region where the token is changed in the plurality of regions based on the recognition result of the each frame of image and the original token information of the each region.

14. The electronic device of claim 13, wherein the recognition result comprises present token information of the each region in the each frame of image; and the processor is configured to:
sequentially compare the present token information of the each region in a present frame of image with the original token information of the corresponding region according to collection time, and
in a case where the present token information of a first region in a first image frame is inconsistent with the original token information, determine the first region as the target region.

15. The electronic device of claim 14, wherein that the present token information of the first region in the first image frame is inconsistent with the original token information comprises at least one of:
a present token amount of the first region is larger than an original token amount;
a present token value of the first region is higher than an original token value;
the present token amount of the first region is smaller than the original token amount; or
the present token value of the first region is lower than the original token value.

16. The electronic device of claim 14, wherein the processor is further configured to:
read configuration information of the game table, the configuration information comprising type information of the each region on the game table;
determine a type of the target region based on the configuration information; and
in response to that the type of the target region is inconsistent with a type of the region that allows the token to be changed, determine that the target region is not the preset region that allows the token to be changed.

17. The electronic device of claim 12, wherein the processor is further configured to:
in a case where the target region is the preset region that allows the token to be changed, send a notification message to a management system of the game table,
wherein the management system is in communication connection with an edge computing node; and the notification message is configured to instruct not to send the alarm information to the target region in response to detecting that the token in the target region is changed.

18. The electronic device of claim 14, wherein the processor is further configured to:
in a case where the target region is the preset region that allows the token to be changed, determine token change data of the target region based on the at least one frame of image in the game prop operating stage; and
store the token change data of the target region in a cache of the game.

19. The electronic device of claim 17, wherein the processor is further configured to:
in a case where the target region is the preset region that allows the token to be changed, determine token change data of the target region based on the at least one frame of image in the game prop operating stage; and
store the token change data of the target region in a cache of the game.

20. A computer-readable storage medium, in which a computer program is stored, wherein the computer program is executed by a processor to implement steps of a method for detecting tokens on a game table, the method comprising:
in response to that a game enters a game prop operating stage after a token placement stage, determining a target region where a token is changed in a plurality of regions for token placement on a game table based on at least one frame of image of the game table, the token in each region being configured to perform payout according to an operation result of a game prop in a payout stage of the game; and
in a case where the target region is not a preset region that allows the token to be changed, generating alarm information for the target region.
